(19) United States
(12) Patent Application Publication
(10) Pub. No.: US 2014/0108422 A1
(43) Pub. Date: Apr. 17, 2014

(54) Method and System of Online Collaboration Between Multiple Users

(71) Applicants: Alex Taylor, St Peter Port (GB); Brent McNish, London (GB)

(72) Inventors: Alex Taylor, St Peter Port (GB); Brent McNish, London (GB)

(21) Appl. No.: 13/649,763

(22) Filed: Oct. 11, 2012

(51) Int. Cl. G06F 17/30

(52) U.S. Cl. 707/748; 707/E17.032; 707/E17.033

(57) ABSTRACT

In a method of online collaboration between multiple users, a subject for debate (e.g. a problem to be solved) is posted on a website. A number of keywords are assigned to the subject to categorize it (e.g. economics, healthcare, politics, hospitals). Proposals for the subject (e.g. possible solutions) are submitted by users and posted on the site. Other users give their opinion of these proposals through a rating system that allocates points to the proposal, the rating being based on a number of factors. These include but are not limited to: the opinion of the user rating the proposal (e.g. good, bad, great, very bad); and the points attained by that user's own proposals in related subjects. Thus, ratings submitted for proposals reflect demonstrated expertise of users, giving a more meaningful result.

### BACKGROUND OF THE INVENTION

The present invention relates to methods and systems of online collaboration between multiple users.

Computer networks have enabled multiple users to connect with common sources of data and to communicate between themselves. Initially, networks tended to be fairly local but, with the present widespread use of the Internet, physical location of users is often immaterial.

A recent area of development for the Internet has been to facilitate collaboration of large, distributed groups around a common cause.

The ‘crowdsourcing’ systems that support this try to optimise the participation of all parties and to overcome the inherent issues around prioritisation and organisation of participants' contributions in order to attain productivity from their efforts.

For example, US 2009198565 discloses an idea collaboration system that accepts and displays user-submitted ideas and allows other users to comment on the ideas and rank them accordingly. Each user registered on the system can rate other user's submissions, whereby the ratings provide a means of ranking the registered users. The ranking may also be calculated mathematically by taking into account attributes such as the number of posts that the user has submitted, the number of positive comments received, and the number of connections the user has made with other registered users.

Other proposals for online debating and idea collaboration, incorporating means to rate the contributions and rank the contributors, include the following: US 2009199104, US 2012054281, US 2009271481, US 2007094601, WO 2012072651, US 2007083423, US 2011185291, US 2009240516, US 2009063991, US 2010049683, US 2008184122, WO 0150279, US 2008222279, US 2004186738, TW 200949594, US 2012030197, US 2008183829, US 2011258055.

Although such prior proposals afford various means of interaction between users, the quality of review can be very variable.

### BRIEF SUMMARY OF THE INVENTION

Preferred embodiments of the present invention aim to optimise the quality of content produced by groups collaborating in online communities by instituting an advanced rating system. This system enables the community itself to identify content of highest quality. It does so by learning the relative areas of expertise of each participant and applying this knowledge when valuing their judgment of other participants' contributions.

According to one aspect of the present invention, there is provided a method of online collaboration between multiple users, the method comprising the steps of:
a. posting a subject on an online site;
b. assigning to the subject a plurality of keywords relevant to the subject;
c. posting on the site proposals that are submitted by users in relation to the subject;
d. assigning to the proposals scores that are submitted by users in relation to the proposals;
e. according to a user a ranking that is proportional to (i) scores that the user has received from other users for prior proposals and (ii) correlation between keywords assigned to the prior proposals and keywords assigned to a current proposal; and
f. weighting a score submitted to a proposal by a user, by a factor that is proportional to the ranking of the user as determined in step e.

Preferably, said scores are selected by users from a predetermined range.

Preferably, said weighting step comprises multiplying a selected score by said factor.

Preferably, said scores include both positive and negative scores.

A method as above may include the further step of posting on the site comments that are submitted by users in relation to the subject.

A method as above may include the further step of posting on the site comments that are submitted by users in relation to the proposals.

The subject may be a problem to be solved and the proposals may be proposed solutions to the problem.

The subject may be content to be generated and the proposals may be proposed items to be included in the content.

A method as above may include the further step of comparing scores that are submitted by users in relation to the proposals and posting on the site one or more highest scoring proposal as a winning proposal.

Preferably, said highest scoring proposals are presented as a leaderboard, with highest score first and subsequent scores in decreasing order.

A current proposal may be derived from a previously posted proposal.

A method as above may include the step of posting on the site details of at least one prior proposal from which the current proposal has been derived.

A subsequent proposal may be derived from a current proposal.

A method as above may include the step of posting on the site details of at least one subsequent proposal that has been derived from the current proposal.

The invention also extends to a system for online collaboration between multiple users, the system comprising a server arranged to host an online site and a plurality of clients arranged to access the online site, wherein:
a. the server is arranged to post a subject on the online site and to assign to the subject a plurality of keywords relevant to the subject;
b. the clients are arranged to submit to the online site proposals that are submitted by users in relation to the subject;
c. the server is arranged to post said proposals on the online site;
d. the clients are arranged to assign to the proposals scores that are submitted by users in relation to the proposals;
e. the server is arranged to accord to a user a ranking that is proportional to (i) scores that the user has received from other users for prior proposals and (ii) correlation between keywords assigned to the prior proposals and keywords assigned to a current proposal; and
f. the server is arranged to weight a score assigned to a proposal by a user, by a factor that is proportional to the said ranking of the user.

For ease of reference, the term ‘online’ is used in this specification to refer to accessibility over a computer network.

### BRIEF DESCRIPTION OF THE SEVERAL VIEWS OF THE DRAWING

For a better understanding of the invention, and to show how embodiments of the same may be carried into effect, reference will now be made, by way of example, to the accompanying diagrammatic drawings, in which:

FIG. 1 shows a web page on which a subject for debate has been posted, together with various proposals relating to the subject for debate;

FIG. 2 shows another web page on which a particular one of the various proposals is shown in more detail, with options for a user to allocate points to the proposal;

FIG. 3 shows another web page giving details of a particular user and his ranking; and

FIG. 4 illustrates a system for carrying out a method of online collaboration between multiple users.

In the figures, like references denote like or corresponding parts.

### DETAILED DESCRIPTION OF THE INVENTION

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

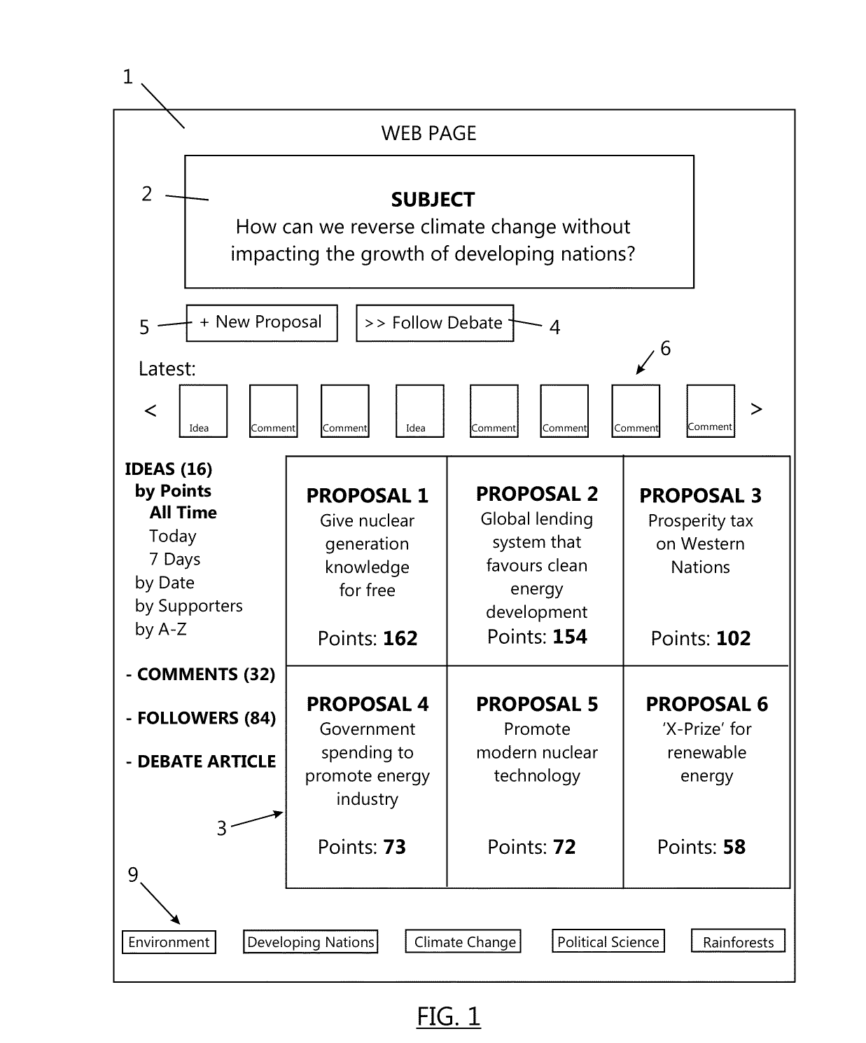

FIGS. 1 to 3 show various aspects of a method of online collaboration between multiple users. FIG. 1 shows a web page 1 in which a subject for debate is shown in box 2. In this example, the subject for debate is a problem to be solved. The problem in this case is “How can we reverse climate change without impacting the growth of developing nations?”. The problem has been posted on the web page 1 by the website host and may have been suggested by one of the multiple users.

The subject is categorised by up to four relevant keywords or “tags”, which are assigned to the subject by the website host. This enables users of the system to identify subjects for debate that are relevant to their own area of interest. By way of example, icons 9 may be provided on the web page 1 (and/or other web pages) to link to subjects for debate that are relevant to respective keywords or tags.

The keywords or tags also have a further function in facilitating a meaningful ranking of users who may comment on proposed solutions to the problem that is posed and/or assign points to the proposed solutions.

In this example, the subject for debate is expressed in simple terms. It may be accompanied by a more detailed explanation and/or discussion. However, a brief statement of the subject may be considered conducive to attracting proposals for solutions without preconceived limits.

Also posted on the web page 1 are a number of proposed solutions to the problem that is posed in the subject box 2. These are listed as PROPOSAL 1 to PROPOSAL 6 in box 3. Each of the proposals has a brief synopsis and an indication of the number of points that it has scored to date. It may also identify the user who submitted it. In this example, the proposals are presented in ranked order of points scored.

The proposals may also be referred to as “Ideas”. On the left hand side of the web page 1, an option is given to users to display the various ideas in different ways. In the illustrated example, the proposals are shown, ranked by points scored over all time. Other options are points scored today or over the last 7 days. Instead of being ranked by points, the proposals may be ranked by date, names of supporters, or simply alphabetically (A-Z). Although only six proposals are shown in FIG. 1, box 3 may scroll to show subsequent proposals, or a link may take the user to subsequent pages. As will readily be appreciated by the skilled reader, a user may select displays simply by clicking on the options shown at the left-hand side of the screen.

Other options at the left-hand side of the screen include links to comments that have been submitted on the subject and/or proposals, names of “followers” of the subject and/or proposals, and a “debate article” that discusses the subject for debate in more detail.

A user can “follow” a debate by clicking on link 4 and submit a new proposal or idea by clicking on link 5. A scrolling row of icons 6 show latest posts, by way of ideas and comments, which may be confined to the subject shown in box 2 or apply to the whole site. If the latter, the icons 6 may also indicate new subjects for debate.

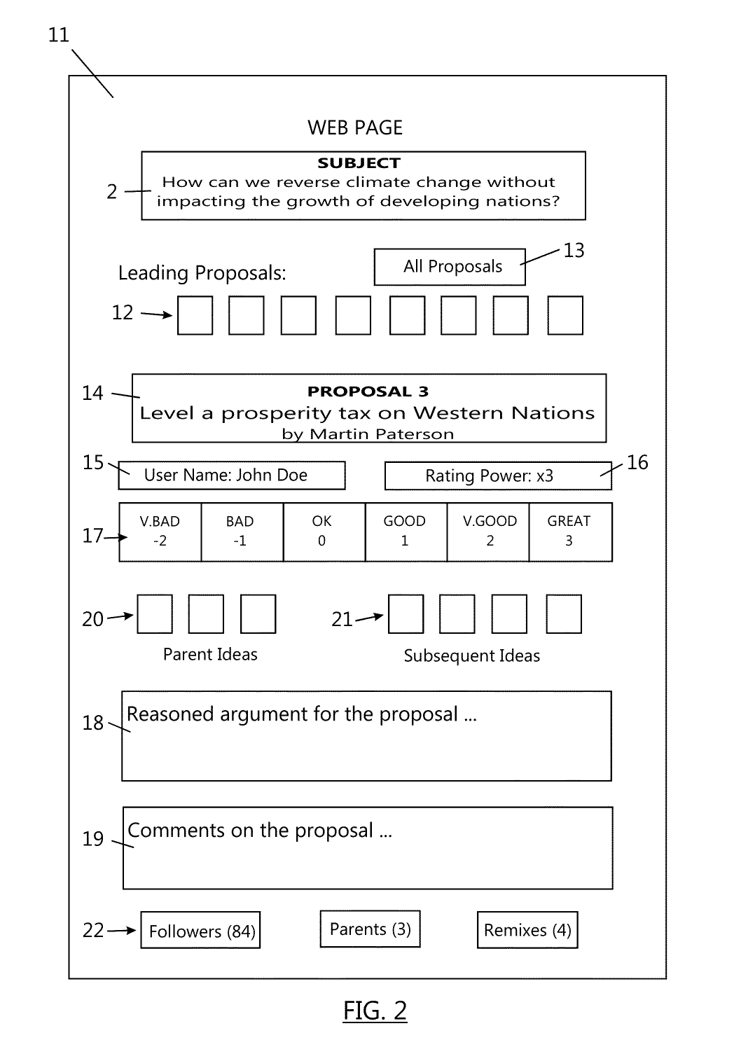

The web page 11 that is shown in FIG. 2 shows PROPOSAL 3 of FIG. 1 in more detail, together with options for a user to assign a score, or points, to the proposal.

Thus, on page 11, the subject is repeated in box 2. A series of icons 12 show leading proposals (or ideas) for solutions, typically ranked in order of points scored to date. A link 13 provides the user with an option to see all proposals to date.

Box 14 repeats the present Proposal 3, with an indication of the proposer (which may also appear in box 3 on web page 1). Box 15 shows the name of the current user and box 16 indicates the “Rating Power” of the current user, which is indicative of the ranking of the current user.

Box 17 shows six predetermined score options, ranging from Very Bad to Great, and with scores ranging from −2 to +3. The current user can assign a score to Proposal 3 by clicking on one of the options in box 17. The score is multiplied by the Rating Power shown in box 16 which, in this example, is 3.

Box 18 contains a reasoned argument made by its proposer for Proposal 3. It may be a scrollable box and/or may have a link to further pages with further detail.

Box 19 contains comments on Proposal 3 that have been submitted to date by users. Again, this may be a scrollable box and/or may have a link to further pages with further details. Typically, the comments will include an indication of the users that have submitted them.

A series of icons 20 indicate prior proposals or ideas from which the present Proposal 3 has been derived. A further series of icons 21 indicate subsequent proposals or ideas that have been derived from the present Proposal 3. These features provide an incentive for users to build upon or “remix” previous ideas, rather than simply to plagiarise them.

A box 22 provides a link to a list of followers of Proposal 3 and/or the subject at large. Box 23 provides a link to all “parent” ideas from which Proposal 3 has been derived. Box 24 provides a link to all subsequent or “remix” ideas that are derived from Proposal 3.

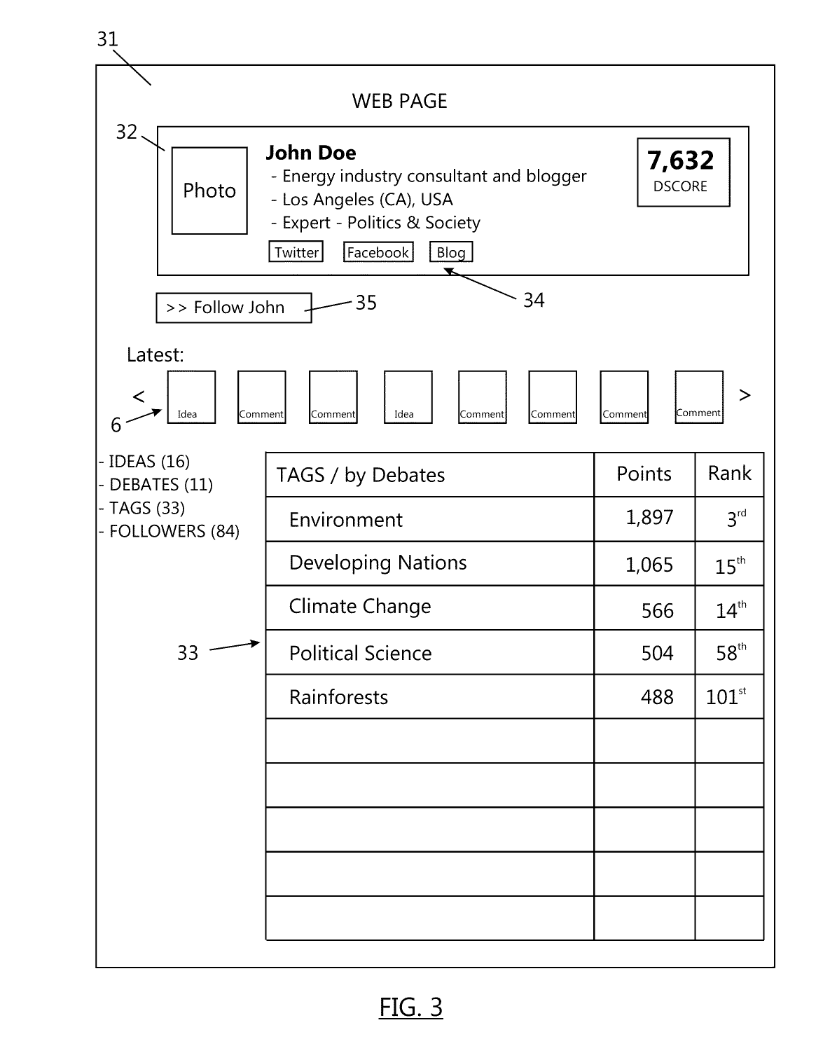

In FIG. 3, web page 31 contains details of user John Doe, who is shown as the current user in FIG. 2. Box 32 contains brief bibliographic details of John Doe, including a photograph, status and location, together with a “score” that he has achieved through using the present website.

In box 33, various keywords or tags are listed, indicating areas in which John Doe has contributed. A “Points” column indicates the number of points (or score) that John Doe has been assigned by other users, in relation to the relevant keyword or tag. A “Rank” column indicates John Doe's ranking in relation to the relevant keyword or tag. The DSCORE that is shown in box 32 is the aggregate of all points that have been assigned to John Doe over all keywords or tags.

Boxes 34 within box 32 provide links to various social or blog sites to which John Doe subscribes. A scrolling row of icons 6 correspond to those shown in FIG. 1, showing latest posts by way of ideas, comments and/or new subjects for debate. Icons 6 may be provided on all webpages.

A link 35 is provided to allow a current user to “follow” John Doe. Links at the left-hand side of page 31 allow a current user to link to all ideas or proposals, all current subjects for debate, all keywords or tags and/or all followers. For example, a user may follow another user, a debate (subject), an idea (proposal), a topic, a keyword (tag). A user following an item will be alerted to any activity around it. So if a user is following another user who posts a new idea (proposal), the user who is following will be notified.

A particular advantage of the illustrated method is the way in which the “Rating Power” (or ranking) shown in box 16 in FIG. 2 is calculated. It does not simply reflect the total number of points that the current user, John Doe, has been assigned by other users over all time. Rather, it reflects both the number of points that John Doe has been assigned and the keywords or tags that are relevant to the current subject for debate.

For example, if the current subject for debate has been assigned all of the keywords or tags shown in box 33 in FIG. 3, apart from Political Science, then the Rating Power shown in box 16 in FIG. 2 may be calculated only on the basis of the points assigned to John Doe for the first three and the fifth keywords or tags shown in box 33 in FIG. 3.

Alternative algorithms may be used for calculating a user's ranking or Rating Power for a particular subject. For example, referring again to box 33 of FIG. 3, all of the points assigned to John Doe for all keywords or tags may be aggregated, but those with reference to keywords or tags that are common to the subject for debate may be multiplied by a factor—e.g. 2 or 3. In addition a user's rating power may be enhanced if they are the originator of the debate (subject)—giving them a more powerful vote when rating ideas (proposals).

The ×3 Rating Power, or weighting factor, that is shown in FIG. 2 by way of example may be derived from relevant John Doe points by various algorithms—or it may be taken from a look-up table.

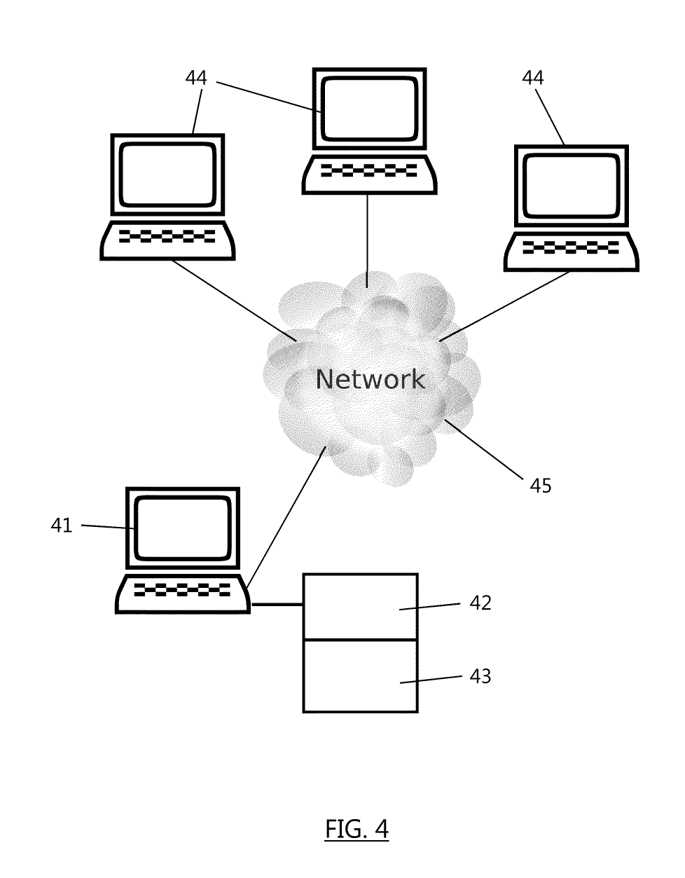

FIG. 4 illustrates a system for carrying out a method of online collaboration between multiple users as described above and illustrated in FIGS. 1 to 3.

In FIG. 4, a computer server 41 is arranged to host the online site exemplified by web pages 1, 11 and 31. To this end, the server 41 comprises a database 42 and a processor 43.

An operator selects via the server 41 the four keywords that are relevant to the subject for debate and the correlation between the keywords and subject is stored in the database 42. Client computers 44 are connected to the computer server 41 via a network 45 which, in this example, comprises the Internet.

The server 41 posts the subject for debate on the online site. Proposals from users, as well as scores that are submitted by users in relation to the proposals, are submitted via the clients 44 and posted on the online site by the server 41.

The server 41 stores in the database 42 all scores that are assigned by other users to a particular user, together with the relevant keywords with which each score is associated. Then, for a given subject and in accordance with a predetermined algorithm, the server 41 is able to calculate via the processor 43 a ranking for each particular user, in proportion to both scores that the user has received from other users for prior proposals and correlation between keywords assigned to the prior proposals and keywords assigned to the current proposal. The server 41 also calculates, via the processor 43 and in accordance with a predetermined algorithm, a weighting factor (“Rating Power”) that is applied to scores assigned by the relevant user to a proposal in relation to the current subject.

It may thus be appreciated that the preferred embodiments of the invention as described above and illustrated in the drawings may provide improved methods and systems of online collaboration between multiple users, with improved quality of review, since greater weight is given to points assigned by users who have been ranked by their peers in relevant fields.

It is to be appreciated that although, in many instances, a network such as the network 45 will conveniently comprise the Internet, it may alternatively comprise any other network that conveniently connects the computer server 41 and the client computers 44. For example, this may be a company intranet or a mobile telephone network. Also, although the various computing devices 41, 44 are conveniently described as “computers”, at least some of them may comprise electronic devices with computing ability, such as (by way of non-limiting example) smart phones, portable tablets, etc.

Although the illustrated embodiments of the invention are described with reference to the submission of proposals to solve problems, the method and systems can be adapted to afford collaboration between users for other purposes—e.g. to generate content for a particular application. The system can be used in any context where the purpose is to produce competitive and collaborative ranking and evolution of discrete pieces of information (e.g. analytical articles, images, videos, etc.) amongst a group of people.

Methods and systems in accordance with the invention may incorporate any of the following features, given just by way of example.

A notification system may alert users when there has been activity relating to a person, topic, debate (subject) or idea (proposal) they are following. E.g. If a new idea is posted in a debate they are following they will be notified.

The notification system may be built into a user interface and signal new notifications by way of a coloured number over a user's image at the top right of the page.

Debate (subject) originators may highlight ideas (proposals) they think are worthy of consideration, bringing them to the attention of users that may have overlooked them.

For users that want to launch debates but do not wish to take part in the scoring and ranking system, a ‘guest contributor’ feature may enable this. Guests appear on the site but are labelled and do not receive points.

A user may be designated as an editor. This affords them privileges on the site such as the ability to delete and edit other user's content

The management and moderation of the site may be outsourced over time to its own user community

The site may use its own mechanisms to improve itself, hosting debates that invite ideas on how it could be made better.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivates) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of online collaboration between multiple users, the method comprising the steps of:
a. posting a subject on an online site;
b. assigning to the subject a plurality of keywords relevant to the subject;
c. posting on the site proposals that are submitted by users in relation to the subject;
d. assigning to the proposals scores that are submitted by users in relation to the proposals;
e. according to a user a ranking that is proportional to (i) scores that the user has received from other users for prior proposals and (ii) correlation between keywords assigned to the prior proposals and keywords assigned to a current proposal; and
f. weighting a score submitted to a proposal by a user, by a factor that is proportional to the ranking of the user as determined in step e.

2. A method according to claim 1, wherein said scores are selected by users from a predetermined range.

3. A method according to claim 2, wherein said weighting step comprises multiplying a selected score by said factor.

4. A method according to claim 1, wherein said scores include both positive and negative scores.

5. A method according to claim 1, including the further step of posting on the site comments that are submitted by users in relation to the subject.

6. A method according to claim 1, including the further step of posting on the site comments that are submitted by users in relation to the proposals.

7. A method according to claim 1, wherein the subject is a problem to be solved and the proposals are proposed solutions to the problem.

8. A method according to claim 1, wherein the subject is content to be generated and the proposals are proposed items to be included in the content.

9. A method according to claim 1, including the further step of comparing scores that are submitted by users in relation to the proposals and posting on the site one or more highest scoring proposal as a winning proposal.

10. A method according to claim 9, wherein said highest scoring proposals are presented as a leaderboard, with highest score first and subsequent scores in decreasing order.

11. A method according to claim 1, wherein a current proposal is derived from a previously posted proposal.

12. A method according to claim 11, including the step of posting on the site details of at least one prior proposal from which the current proposal has been derived.

13. A method according to claim 1, wherein a subsequent proposal is derived from the current proposal.

14. A method according to claim 13, including the step of posting on the site details of at least one subsequent proposal that has been derived from the current proposal.

15. A method according to claim 12, including the step of also posting on the site details of at least one subsequent proposal that has been derived from the current proposal.

16. A system for online collaboration between multiple users, the system comprising a server arranged to host an online site and a plurality of clients arranged to access the online site, wherein:
a. the server is arranged to post a subject on the online site and to assign to the subject a plurality of keywords relevant to the subject;
b. the clients are arranged to submit to the online site proposals that are submitted by users in relation to the subject;
c. the server is arranged to post said proposals on the online site;
d. the clients are arranged to assign to the proposals scores that are submitted by users in relation to the proposals;
e. the server is arranged to accord to a user a ranking that is proportional to (i) scores that the user has received from other users for prior proposals and (ii) correlation between keywords assigned to the prior proposals and keywords assigned to a current proposal; and
f. the server is arranged to weight a score assigned to a proposal by a user, by a factor that is proportional to the said ranking of the user.
